(19) United States
(12) Patent Application Publication
(10) Pub. No.: US 2011/0241247 A1
(43) Pub. Date: Oct. 6, 2011

(54) TAPERED SCREW EXTRUSION PROCESS FOR MAKING SOAP WITH A SECOND PHASE

(75) Inventor: Liem Duc Vu, Berkeley Heights, NJ (US)

(73) Assignee: Colgate-Palmolive Company, New York, NY (US)

(21) Appl. No.: 13/139,093

(22) PCT Filed: Dec. 12, 2008
(86) PCT No.: PCT/US2008/086566

§ 371 Date: Jun. 10, 2011

(51) Int. Cl. B29C 47/04

(52) U.S. Cl. 264/245; 264/299

(57) ABSTRACT

A process utilizing a tapered screw impeller extending at least partly into the extruder cone within the extrude region in a plodder assembly for manufacturing an improved multiphase soap bar product, which enables the use of a broader range of soap materials/formulas, including a broader range of secondary discontinuous phases materials with similar or slightly higher hardness compared to the primary continuous phase hardness, which allows more feasible, easy and convenient production.

### BACKGROUND OF THE INVENTION

In recent years, there has been an increasing consumer demand for aesthetically-unique soap bars. To make the soap bar more attractive, translucent, transparent, and different bar shapes, as well as multiphase and/or multicolored soap bars made from different soap materials and/or different colors, have been created to enhance the attractiveness and consumer appeal of these products.

For example, methods and extrusion apparatus to create striated soap bars have been shown in U.S. Pat. Nos. 3,891,365 and 3,947,200 (both Fischer) and 6,852,260B2 (Vu et al) and to create variegated, multicolored and/or marbled soap bars have been described in U.S. Pat. Nos. 3,823,215 and 3,940,220 (both D'Arcangeli), 3,993,722 (Borcher et al), 4,011,170 (Pickin et al), 6,727,211B1(Aronson et al), and 6,805,820B1 (Myers). An injection molding process using two different components to produce detergent bars comprising distinct zones has been described in U.S. Pat. No. 6,878,319B2 (Browne et al).

### BRIEF SUMMARY OF THE INVENTION

The present invention provides an extrusion process for the production of a solid soap product comprising feeding a soap composition into an extruder having a housing with an inlet and an outlet and a screw impeller traversing the extruder, wherein at least a portion of the housing from the inlet to the outlet of the housing, and ending at the outlet, is tapered to form a portion of the housing with a reduced cross-sectional area, and the screw impeller extends at least partly into the tapered portion of the extruder, where the screw impeller ends, and extruding the soap composition through the extruder.

The present invention also provides a process for producing a multiphase bar soap, comprising: processing a stream comprising a primary soap phase in at least one refiner and then into a plodder, comprising a plodder housing, a feed hopper for receiving material to be extruded, an extruder, an outlet through which material that has been extruder exits and an extruder cone diminishing in cross-section toward and ending at that outlet, via the feed hopper, a screw impeller disposed in the extruder and extending at least partly into the extruder cone; introducing at least one secondary soap phase into the stream of the primary continuous soap phase in the feed hopper of the plodder; and extruding the stream including the primary soap phase and the at-least-one secondary soap phase through the extruder cone with the screw impeller within the extrusion region to produce a bar soap having embedded visually distinct phases.

### BRIEF DESCRIPTION OF THE FIGURES

FIG. 1 is a schematic diagram illustrating a conventional apparatus for extruding billets that will eventually be cut and pressed into bar soap.

FIG. 2 illustrates an embodiment of an apparatus for extruding bar soap, which apparatus comprises a dual-stage vacuum plodder including a tapered screw extending into the extruder cone, in accordance with certain aspects of the present teachings.

FIG. 3 is a detailed sectional view of the tapered screw within the extruder cone region of FIG. 2.

FIG. 3A is a detailed sectional view of the tapered screw within the extruder cone region of FIG. 2 with an inner tapered cone installed inside the extruder cone.

FIG. 4 illustrates another embodiment of an apparatus for extruding billets of bar soap, which apparatus comprises a dual-stage vacuum plodder including an extruder barrel compartment having a tapered screw extending into the extruder cone and an extension cone attached to the extruder cone at the outlet of the extruder cone, in accordance with certain aspects of the present teachings.

FIG. 5 is a detailed sectional view of the tapered screw within the extruder cone and including an extension cone, as shown in FIG. 4.

FIG. 6 illustrates another embodiment of an apparatus for extruding billets of bar soap, which apparatus includes a spider device.

FIG. 7 is a cross-sectional view of the spider device taken along line 7-7′ of FIG. 6.

FIG. 8 illustrates yet another embodiment of an apparatus for extruding soap billets, which apparatus comprises a single-stage plodder including a tapered screw extending into the extruder cone, in accordance with certain aspects of the present teachings.

### DETAILED DESCRIPTION OF THE INVENTION

Ranges are used throughout herein in place of describing each and every value that is within the range. Any value within the range may be selected for the parameter being defined. And all percentage used, unless indicated otherwise, are intended to be percentages by weight.

An extrusion apparatus and method have now been developed for formulating a multiphase soap bar, comprising a first phase and at least one additional phase, where the additional phase(s) may have similar, or slightly higher hardness compared to the hardness of the first phase. In particular, utilizing a tapered screw extending at least partly into the extruder cone (frustum) region for manufacturing a multiphase soap bar produces a better bar aesthetic with visually distinct phases and/or permits the formation of desirable marbleized patterns. The use of such a modified extruder screw design makes the manufacturing of the desired bar aesthetic much more feasible, since simple soap formulas may be used, and no special processes or complicated equipment is needed for making the soap phases, especially for making a harder second soap phase in order that the phases do not excessively deform/blend during extrusion.

Accordingly, an extrusion process is provided for the production of billets of multiphase bars of soap, these bars include a continuous primary soap phase and at least one secondary solid soap phase embedded therein. The process includes passing a stream of a primary continuous soap phase through a first stage of a soap finishing line that includes a refiner having one or more roll mills and a plodder. At least one secondary solid soap phase is introduced into the stream of the primary continuous soap phase via a feed hopper/vacuum chamber later in the plodder design in order to form a combined stream of the primary (continuous) and the secondary (discontinuous) soap phases. The stream having primary and secondary phases is extruded using a screw with a tapered section extending into the extruder cone (frustum) and the stream is formed into billets having embedded visually-distinct phases, which billets are subsequently cut and pressed into bars of soap. The tapered screw is extended sufficiently into the extruder cone to form an “effective” extrusion zone in order that the visually-distinct phases and/or the desirable marbleized patterns are observed in the finished bar. This effective extrusion zone is the region between the end of the tapered screw and the outlet of the extruder cone. In one embodiment, the inlet diameter:outlet diameter ratio is generally up to 3:1. In other embodiments, the ratio is 2.5:1 to 2:1 or 1.5:1 to 1:1. The inlet diameter is the diameter of the extruder cone at the terminus of the tapered screw within the extruder cone and the outlet diameter, measured at the outlet of the extruder cone (frustum), becomes the diameter of the extruded soap billet.

In certain aspects of the invention, the extruder cone optionally comprises an inner tapered cone. In another aspect of the invention, the extruder cone optionally comprises a smaller extension cone (frustum) attached to the outlet of the extruder cone through which the process stream passes. In yet other aspects, the effective extrusion region further comprises a spider device, which may be disposed at the terminus of the tapered screw within the extruder cone, or may be disposed between the outlet of the extruder cone and the beginning of the extension cone, if present.

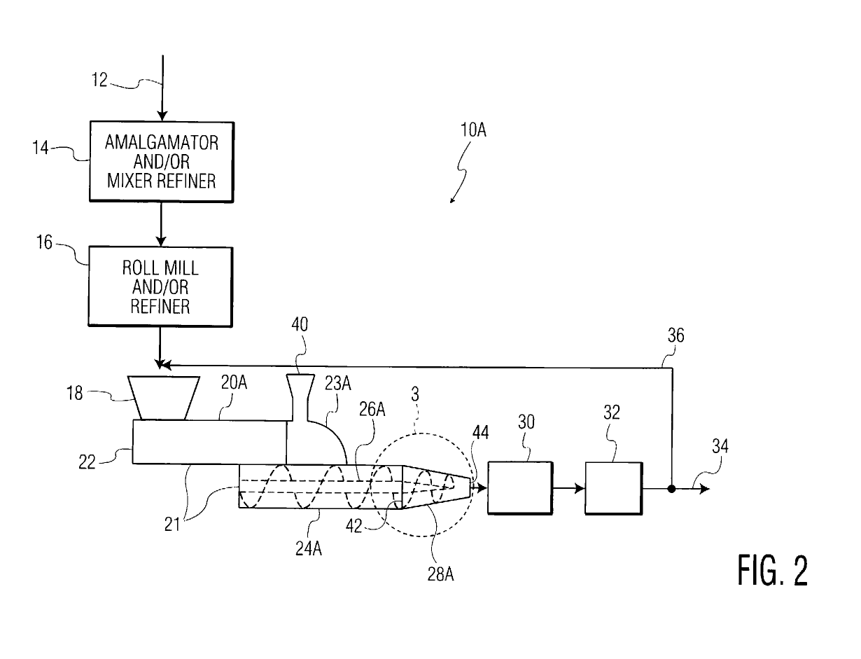

As illustrated in FIG. 2, single-screw and dual-stage (double-barrel) extruders for soap bar manufacturing (soap plodders) typically include one or more feed hoppers, one (single) or two (dual-stage or duplex) extruder barrels in which one or more screw impellers is/are rotatably mounted, and an extruder cone. One or more powdered or granulated soap raw materials is/are fed into the apparatus at one end of the barrel, via a feed hopper, and the material is then conveyed and compressed by the rotating impeller screw(s) through the barrel compartment(s) to the extruder cone (actually a frustum) to produce soap billets, which are then cut and pressed into the desired soap bar shape(s).

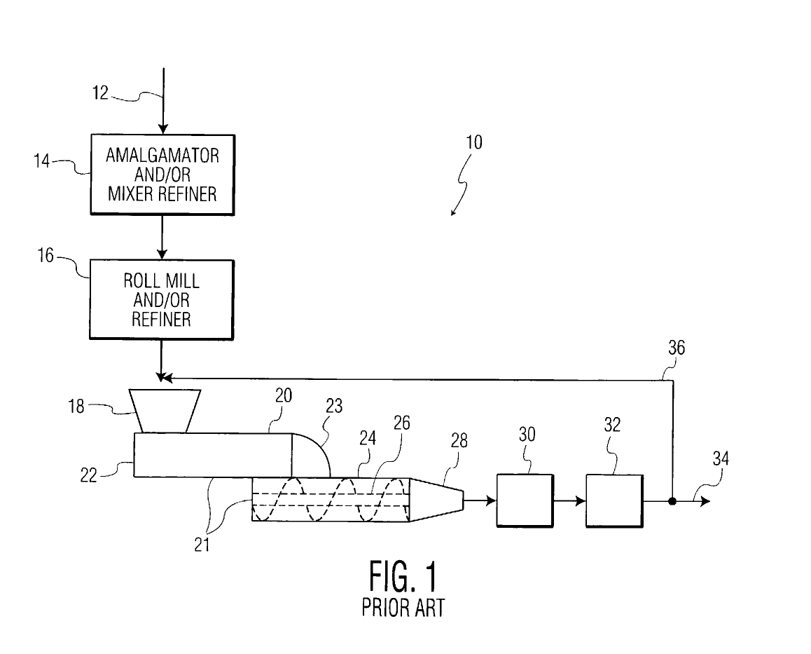

In FIG. 1 (a simplified schematic and omits attendant equipment, such as vacuum-producing devices, motors, actuators, and the like), illustrating a conventional soap finishing line 10 employing a duplex plodder, a process stream 12, typically including soap precursor materials (for example, chips, beads, flakes, chunks, and the like), color, perfume, and other ingredients, is introduced to an amalgamator and/or mixer-refiner 14, where the process stream materials are blended and/or mixed. From 14, the stream is fed to a roll mill and/or refiner 16 (optionally a duplex refiner or a simplex refiner, combined with one or more roll mills), for further homogenization, then fed into a feed hopper 18 and into a first (upper) barrel compartment 22 of a double-barrel (duplex) soap plodder (extruder) 21, having two distinct extruder barrel compartments, which plodder compacts or compresses the stream, subjecting it to a certain amount of mixing, and moves it from left to right in the drawing toward a chamber/connector 23, where the soap may be subjected to a vacuum to remove any air bubbles and/or where a coloring agent or dye or other additives may be added and/or the soap may be cut into segments before being gravity-fed into a second (lower) barrel compartment 24 of the plodder. In this barrel, a rotating screw compacts and forces the soap into and through extruder cone (frustum) 28, from which it forms billets, which billets optionally enter a cutter 30, where the billets are cut to form discrete soap bars, and a press 32 for shaping and/or imprinting the cut soap bars. The solid personal care/laundry/household cleaning soap bar products 34 then exit the soap-finishing line 10, with the excess soap material being recycled by suitable means 36 back to the feed hopper 18 for reprocessing in the dual-stage plodder 20.

When multiphase bar soaps have been manufactured via typical extruders in soap-finishing line processes, this production has often involved complex processes for selecting and preparing appropriate soap compositions for each phase. For example, in order to maintain visually-distinct phases while extruding multiphase bar soaps, hardness of the respective phases is selected to facilitate incorporation or embedding of the second phase into the first phase, while not excessively blending, mixing, smearing, or stretching the second phase within the first phase, in order to achieve a desirable aesthetic. Thus, in conventional processes, when extruding bar soap, in which a second phase is embedded within a first phase, a second solid phase is often selected to have a significantly higher hardness as compared to the primary soap phase, while the secondary phase suitably withstands various physical forces associated with the plodding process in the soap plodder in order to maintain desirable visually-distinct phases.

The instant extruder design and extrusion process overcomes the shortcomings associated with standard soap extrusion processes for making a multiphase soap bar, such as those having a first solid phase and a discrete second solid phase dispersed therein (e.g., a translucent, opaque or other second phase). As used herein for convenience, a multiphase soap is referred to as having a first continuous phase and a second discrete, discontinuous phase dispersed therein, however, the present disclosure contemplates a plurality of phases in a solid soap composition. In certain aspects, there are at least two visually- or compositionally-distinct phases.

In accordance with the present disclosure, an extruder in the bar soap manufacturing process has a tapered screw extending into the extruder cone region, to form an “effective” extrusion zone which has shorter length and a relatively low ratio of cross-sectional inlet diameter to outlet diameter in that effective extrusion region, which eliminates the key smearing/stretching that conventionally occurs in the plodding process.

Processes are provided in accordance with the present teachings that form solid soaps by using a plodder and extrusion-supporting devices that enable a wider selection of soap material properties and compositions (e.g., phases) and provide an aesthetically-distinct and—pleasing multiphase bar soap. As noted above, an extrusion region is designed to be shorter and to have a lower ratio of cross-sectional areas of the inlet to the outlet, respectively, as compared to conventional designs.

In certain aspects, an extrusion process for the production of a solid bar of soap, comprising a continuous primary soap phase and at least one secondary solid soap phase embedded therein, is depicted in the soap-finishing line 10A in FIG. 2, the configuration and component numbering of which is similar to that of line 10 in FIG. 1. The raw materials of a first primary soap phase are introduced in process stream 12, which enters an amalgamator/mixer refiner 14 and roll mill and/or refiner 16. The process stream enters hopper 18 to be fed into a dual stage plodder 20A, having first- and second-stage/extruder cylindrical compartments 21. The second-stage screw 26A differs from that the second screw 26 of FIG. 1, as will be discussed in more detail below. The process stream material (first primary soap phase materials) exits the first-stage extruder barrel compartment 22 and enters into a chamber/connector 23A between the respective extruder compartments 21.

At least one secondary solid soap phase is introduced via a second process stream to the first process stream (primary soap materials) via an inlet 40 in the chamber/connector 23A to form a combined stream of the primary and secondary soap phases. The second process stream may be a liquid or may be in solid form (chips, flakes, beads, chunks, particulates, and the like) as it is introduced in chamber/connector 23A. The physical form of the second process stream may be selected based upon the desired aesthetics in the multiphase solid bar soap. For example, the shape and size of solid secondary phases are selected such that they result in desired size, and ultimate visual effects/aesthetics in the bar soap, as appreciated by those of skill in the art. Furthermore, the process may vary from the apparatus shown in FIG. 2, such as, for example, the second process stream may be injected in liquid form into various points along the extruder barrel compartment 24A or extruder cone 28A in order to achieve different aesthetics upon mixing, for example, for a marbling effect. Also, the point of introduction of the secondary soap phase may be at inlet 18 prior to entry into the second-stage extruder barrel compartment 24A.

In one embodiment, there is minimal mixing, stretching, and/or smearing of the secondary soap phase during the extrusion process. By minimal it is meant that two distinct phases can be viewed in the final soap product by an ordinary observer having 20/20 vision or corrected to 20/20 vision at a distance of 30 cm.

The screw impeller shaft 26A forces the mixture of the primary and secondary soap phases through an outlet in a extruder cone (frustum) end 44. As noted above, in various aspects, the stream is passed through a extruder cone having a tapered screw extending thereinto.

In certain aspects of the present disclosure, the second-stage screw is modified to have a tapered screw 26A or an attached tapered screw part at the end of 26A (not shown), which extends at least into a portion of the extruder cone, having an increasingly-reduced diameter. Thus, rather than having an extruder cone, such as 28 in FIG. 1, the second-stage screw 26A, or an attached tapered screw part, if present, tapers to a narrower diameter as it approaches terminal end 44. However, the extruder cone may further include other components, such as an inner cone installed inside the extruder cone, an extension cone attached to the terminal end 44 of the extruder cone 28A, or a spider device installed at the terminus of the tapered screw inside the extruder cone, or attached at the connection point between the extruder cone and extension cone.

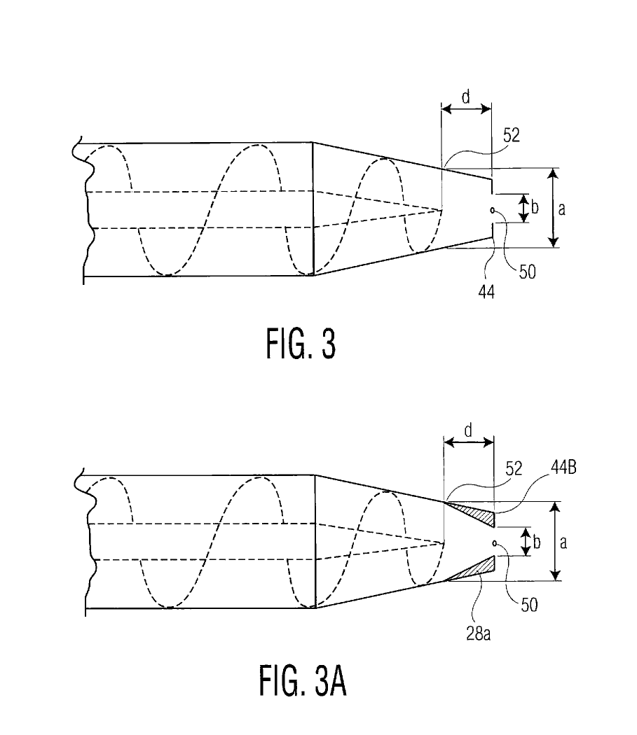

In accordance with various aspects of the present teachings, the modified second stage screw 26A shown in FIG. 2 is shown in more detail in FIG. 3. The screw impeller shaft 26A is designed to move the process stream material through the second-stage extruder barrel compartment 24A to the terminal end 44 of the extruder cone, which results in an effective extrusion zone with inlet region 52 and material is extruded through outlet 50. The effective extrusion zone has a first (inlet) diameter denoted by “a” and a second diameter denoted by “b” at outlet 50. The first cross-sectional diameter “a” corresponds to the point of the end of the tapered screw 52 the inlet of the effective extrusion zone. The second cross-sectional diameter “b” corresponds to the end of the effective extrusion zone where the soap billet exits 44, which has the same diameter as the extruded billet. In various aspects, the ratio of the inlet and outlet diameters (a:b), also referred to herein as the inlet diameter to outlet diameter ratio, is 3 to 1; preferably 2.5 to 1; more preferably 2 to 1; still more preferably 1.7 to 1, and in certain aspects, 1.5 or 1 to 1. Such ratios of an inlet diameter to the outlet diameter in the extrusion or convergence of soap mixtures into billets, and ultimately, soap bars, are particularly desirable, and also applied to the overall effective extrusion region (including other components, such as a tapered inner cone, any extension cone and/or any spider dies). In the conventional process, this effective extrusion zone usually has an inlet diameter to outlet diameter ratio of approximately between 4.5 to 1 and 10 to 1.

In various aspects, a distance “d” defined by the inlet region 52 to the outlet 50 is minimized to be relatively short, as compared to conventional extrusion equipment. For example, in certain aspects, “d” is selected to be less than or equal to 200 mm, preferably less than or equal to 150 mm, optionally less than or equal to 80 mm. In certain aspects, “d” is 40 to 80 mm, in comparison to conventional extrusion equipment, where it is 450 mm to 650 mm. In this manner, multiphase soap bars made by a process using a plodder extrusion apparatus having an effective extrusion zone or convergence zone with a relatively low inlet diameter to outlet diameter ratio and/or reduced length between inlet and outlet, provide an extruded soap bar billet having an improved aesthetic and further enables the use of a wider variety of soap compositions and hardness properties for the respective phases.

With renewed reference to FIG. 2, after exiting the extruder cone (frustum) comprising a tapered screw therein, the process stream mixture of primary and secondary phases then passes through cutter 30 and press 32 to form the solid multiphase soap bars having the first and second soap phases desirably mixed therein.

In certain aspects, an extruder cone containing a tapered screw may further include an inner cone 28A installed within it toward the end of the extruder cone, which similarly provides an effective extrusion region with suitably low inlet diameter to outlet diameter ratio, such as shown in FIG. 3A. The soap-finishing line is similar to the embodiments already discussed. The inlet diameter to outlet diameter ratio is similar to that described above. The first (inlet) diameter “a” occurs at inlet 52, which is compared with a second (outlet) diameter “b” at an outlet 50 of the tapered inner cone (frustum). Similarly, the extrusion section length “d” extends from inlet 52 to outlet 50.

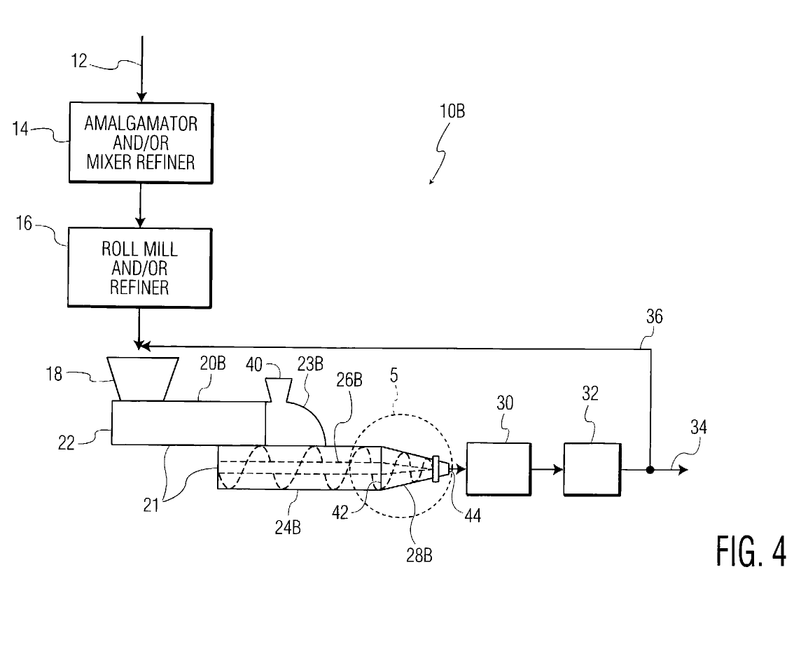

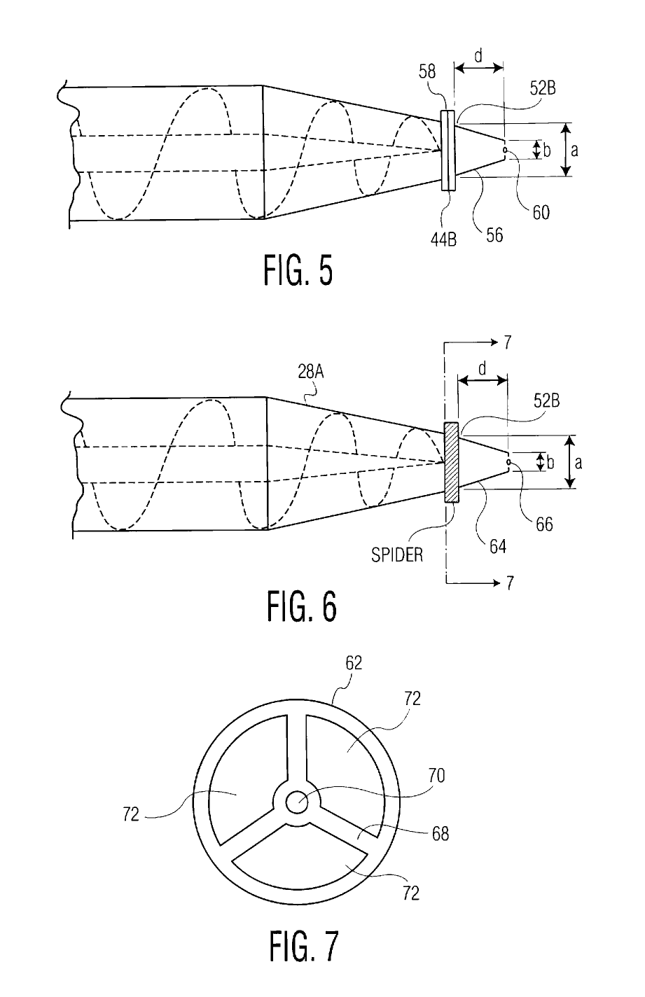

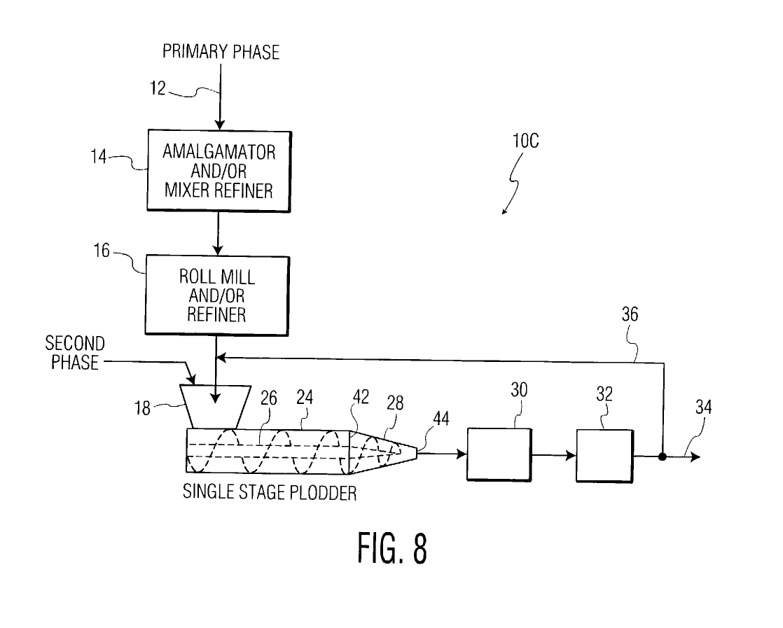

In certain aspects, a extruder cone containing a tapered screw may further include an extension cone attachment, which similarly provides an effective extrusion region with suitably low inlet diameter to outlet diameter ratio, such as shown in FIGS. 4 and 5. The soap-finishing line is similar to the embodiments already discussed, except that the dual stage vacuum plodder 20B has an extension cone 56 attached to a terminal end 44B. The extension cone is optionally coupled to the terminal end 44B via respectively mating flanges 58, for example. The inlet diameter to outlet diameter ratio is similar to that described above; however, the first (inlet) diameter “a” occurs at inlet 52B, which is compared against a second (outlet) diameter “b” at an outlet 60 of tapered extension cone (frustum) 56. Similarly, the extrusion section length “d” extends from inlet 52B to outlet 60 of the extension cone 56.

FIGS. 6 and 7 show an alternate embodiment of the multiphase extrusion plodder device, where the extruder cone 28A further includes a spider attachment device 62 disposed between the terminal end 44 of the extruder cone 28A and an extension cone 64. Spider dies are well known in the art and an exemplary configuration is shown in FIG. 7, where spider 62 has a plurality of spokes 68, which converge at 70, forming apertures 72, through which the process material flows as it passes from the terminal end 44 of the extruder cone (frustum) 28A, then through the extension cone 64 and finally extruded out an outlet 66, as shown in FIG. 6. Thus, the effective extrusion region has an overall ratio of respective diameters of the inlet 52 to the outlet of the extension cone 66, in other words, a ratio of inlet diameter to outlet diameter, represented by a:b. Besides its supporting function for the screw centralization, it can also used in the present disclosed processes to create a desired marbleized pattern. As the process stream passes through apertures 72 of spider device 62, certain deformation/flow patterns of the soap material occur, thus enabling achievement of the desired aesthetics in the extruded billets and eventual soap bars.

In certain other aspects, the dual-stage plodder is replaced with a single-stage plodder with tapered screw extending at least partly into the extruder cone. In another aspect, the dual-stage plodder may also be combined with other devices, such as an inner cone, an extension cone and/or a spider device.

In another embodiment, the tapered screw has at least one groove extending in a longitudinal direction within the extruder cone.

In another embodiment, the at-least-one secondary solid soap phase includes a translucent soap.

In another embodiment, the at-least-one secondary solid soap phase includes an opaque soap.

The multiphase soap billets and bars formed in accordance with the present teachings include a continuous phase and a discontinuous phase. Desirably, the moisture content of the second phase may be much higher when such a second phase is used in accordance with the extrusion processes of the present disclosure, as compared to such use in conventional multiphase soap extrusion processes. In one embodiment of the instant invention, the translucent soap chip has a typical moisture content of 16% to 18% as compared to a conventional multiphase soap extrusion process with ≦12% moisture. A second phase having a higher moisture content typically has a correspondingly-reduced hardness value. In another embodiment, a continuous phase and a discontinuous phase solid mass are combined in a solid multiphase soap bar, by adding together the materials for the respective phases in a mixer at a defined temperature range (35 to 55° C., or 38 to 45° C.), followed by extruding and molding to form the final billets.

### Continuous Solid Soap Phase

The bar composition comprises 55 to 99% of the continuous phase, in another embodiment 75 to 95%, and in still another embodiment 80 to 90%.

The continuous phase includes a surfactant or detergent base suitable for cleansing the skin and optionally a plasticizing agent used to control its consistency.

### Discontinuous Phase

The discontinuous phase may represent 1 to 35% of the bar in one embodiment, 5 to 25% in another embodiment, and 10 to 20% in yet another embodiment. It is generally the shape, distribution and surface quality (e.g., how visually distinctive) of the discontinuous phase that gives the bar a pleasing visual aesthetic, and in certain aspects, an artisan-crafted quality.

In certain aspects, the discontinuous phase domains of the solid multiphase soap bar may have a variety of shapes. For example, the domains may appear in cross-section to approximate oblate or prolate spheroids, disks, cylinders, prisms, rhomboids, cubes or crescents, or they may have irregular shapes. In certain aspects, such discontinuous phase domains have a longest dimension of 3 to 70 millimeters in length, in others 5 to 50, and in still others 5 to 35 millimeters. As discussed above, the discontinuous phase domain is optionally introduced via liquid injection of the discontinuous phases, which may create ribbons, stripes, marbling, and the like.

Further, either the continuous or discontinuous phase may be made multicolored, e.g., marbleized, through the judicious use of coloring agents/dyes, as is well known in the art.

What is claimed is:

1. An extrusion process for the production of a solid soap product comprising feeding a soap composition into an extruder having a housing with an inlet and an outlet and a screw impeller traversing the extruder, wherein at least a portion of the housing from the inlet to the outlet of the housing, and ending at the outlet, is tapered to form a portion of the housing with a reduced cross-sectional area, and the screw impeller extends at least partly into the tapered portion of the extruder, where the screw impeller ends, and extruding the soap composition through the extruder.

2. The extrusion process of claim 1, wherein the tapered potion of the extruder is an extruder cone.

3. The extrusion process of claim 1, wherein the portion of the extruder screw that is disposed in the tapered portion of the housing is tapered.

4. The extrusion process of claim 1, wherein the potion of the extruder screw that is disposed in the tapered portion of the housing has a tapered part attached at the end of the extruder screw.

5. The extrusion process of claim 1, wherein the ratio of the diameter of the extruder housing at the end of the screw impeller to the diameter of the extruder housing at the outlet of the extruder is 3 to 1 or less.

6. The extrusion process of claim 1, wherein the solid soap product comprises a continuous primary soap phase and at least one secondary solid soap phase embedded therein, the process comprising:
(a) feeding the primary soap phase into a first stage of a vacuum plodder having a first stage and a second stage and extruding the primary soap phase through the first stage of the vacuum plodder and into the second stage of the vacuum plodder;
(b) introducing the at-least-one secondary solid soap phase into the second stage of the vacuum plodder to form a mixture of the primary and the secondary soap phases; and
(c) extruding the mixture through the remainder of the second stage of the plodder.

7. The extrusion process of claim 1, wherein an inner tapered cone with an inlet and an outlet is installed inside the tapered portion of the extruder housing such that the outlet of the inner tapered cone is attached to the outlet of the extruder housing.

8. The extrusion process of claim 6, wherein the tapered portion of the extruder housing comprises an extension cone attached to the outlet of the extruder housing, and through which the mixture of the primary and the secondary soap phases passes after exiting the tapered portion.

9. The extrusion process of claim 6, wherein in the second stage at least one groove in the extruder housing extends in a longitudinal direction along and into the tapered portion.

10. The extrusion process of claim 1 further comprising a spider device disposed at the end of the tapered portion of the extruder.

11. A process for producing a multiphase bar soap, comprising:
processing a stream comprising a primary soap phase in at least one refiner and then into a plodder, comprising a plodder housing, a feed hopper for receiving material to be extruded, an extruder, an outlet through which material that has been extruded exits and an extruder cone diminishing in cross-section toward and ending at that outlet, via the feed hopper, a screw impeller disposed in the extruder and extending at least partly into the extruder cone;
introducing at least one secondary soap phase into the stream of the primary continuous soap phase in the feed hopper of the plodder; and
extruding the stream including the primary soap phase and the at-least-one secondary soap phase through the extruder cone with the screw impeller within the extrusion region to produce a bar soap having embedded visually distinct phases.

12. The extrusion process of claim 11, wherein an inner tapered cone is installed inside the extruder cone just preceding the outlet of the extruder.

13. The extrusion process of claim 11, wherein the extruder cone comprises an extension cone attached to its end and through which the primary soap phase and the at-least-one secondary soap phase passes after exiting the extruder cone.

14. The extrusion process of claim 11, wherein at least one groove extends in a longitudinal direction along the housing of the plodder and into the extruder cone.

15. The extrusion process of claim 11, wherein the ratio of the diameter of the plodder housing at the end of the screw extruder to the diameter of the extruder housing at the outlet of the extruder is 3 to 1 or less.

16. The extrusion process of claim 11, wherein there is minimal mixing, stretching, and/or smearing of the secondary solid soap phase during the extrusion process.

17. The extrusion process of claim 11 further comprising a spider device disposed at the end of the tapered portion of the extruder.

18. The extrusion process of claim 11, wherein a distance from the end of the screw impeller to the outlet is less than or equal to 200 mm.
